(19) United States
(12) Patent Application Publication
(10) Pub. No.: US 2025/0372761 A1
(43) Pub. Date: Dec. 4, 2025

(54) ENERGY STORAGE SYSTEM INCLUDING DUAL SIDE COOLED BATTERY MODULE

(71) Applicant: Fluence Energy, LLC, Arlington, VA (US)

(72) Inventors: Beth Schroeder, Lake Orion, MI (US); Jordan David Petrie, Neenah, WI (US); Kathryn Corine Streng Callahan, Golden, CO (US)

(73) Assignee: Fluence Energy, LLC, Arlington, VA (US)

(21) Appl. No.: 19/222,985

(22) Filed: May 29, 2025

Related U.S. Application Data
(60) Provisional application No. 63/654,548, filed on May 31, 2024.

(51) Int. Cl. H01M 10/6557; H01M 10/613; H01M 10/653; H01M 50/204; H01M 50/367

(52) U.S. Cl. CPC H01M 10/6557; H01M 10/613; H01M 10/653; H01M 50/367; H01M 50/204

(57) ABSTRACT

An energy storage system includes a battery pack, and a plurality of battery modules arranged within the battery pack. Each of the plurality of battery modules includes a battery module enclosure, a plurality of battery cells arranged within the battery module enclosure, and a plurality of cold plates arranged within each of the plurality of battery modules. The plurality of battery cells is arranged in a plurality of layers, and at least one of the plurality of cold plates is arranged adjacent to one of a bottom side of one of the plurality of layers, and at least another of the plurality of cold plates is arranged adjacent to a top side of the one of the plurality of layers.

### CROSS REFERENCE TO RELATED APPLICATION

This application claims the benefit of, and right of priority to, U.S. Provisional Patent Application No. 63/654,548, filed May 31, 2024, and entitled “ENERGY STORAGE SYSTEM INCLUDING DUAL SIDE COOLED BATTERY MODULE,” the contents of which are expressly incorporated by reference as if fully set herein.

### INTRODUCTION

The concepts described herein relate generally to energy storage systems, and more specifically, to modular energy storage systems including battery modules that have dual side cooling.

Modular energy storage systems include multiple individual energy storage systems interconnected to provide varied levels of storage capacity. Energy storage systems can be used to store additional power produced by an external power source during periods of reduced demand and provide additional power to external power sources during periods of increased demand.

Each individual energy storage system includes multiple battery modules, each containing multiple battery cells, which are cooled by a single cold plate adjacent to one side of the battery cells. However, under high-load conditions, the battery cell internal temperatures may increase to a level that may lead to overheating, cell degradation, and thermal runaway.

As regulation of the internal temperature of the battery cells can affect both the efficiency and longevity of the battery cells, it would follow that both the efficiency and longevity of the energy storage system in which it resides would also be affected.

As such, it would be advantageous to increase the ability to regulate the internal temperature of the battery cells to prolong the life cycle of the battery cells, and increase their efficiency, thereby keeping both the battery cells, and their respective energy storage systems, working longer and more efficiently.

### SUMMARY

In view of the above discussion, it is useful to develop an energy storage system including battery modules having dual side cooling that lowers an internal temperature of the individual battery cells while providing both structural and venting capabilities, thus combining the thermal, structural, and venting capabilities.

The concepts disclosed herein relate to an energy storage system that includes battery modules having dual cold plates. The dual cold plates provide cooling to opposing sides of the individual battery cells within each of the battery modules, which may lower the internal temperature of the individual battery cells and decrease the temperature difference across each of the battery cells.

Having dual cold plates may provide additional structural capability to the battery module by allowing the battery cells to be stacked vertically with respect to one another, which may increase the volumetric efficiency of the battery module. Further, either one or both cold plates may include channels, which may provide structural and venting capabilities.

An energy storage system according to the present disclosure may include a battery pack, and a plurality of battery modules arranged within the battery pack. Each of the plurality of battery modules may include a battery module enclosure and a bottom plate.

A plurality of battery cells may be arranged within each of the plurality of battery modules. The plurality of battery cells may be arranged in a plurality of columns, which may include, for example but not limited to, a first column that may be arranged adjacent to a second column, and a third column that may be arranged adjacent to the second column. Each of the plurality of columns may include, for example but not limited to, a first layer, a second layer and a third layer.

A plurality of cold plates may be arranged within each of the plurality of battery modules. The plurality of cold plates may include, for example but not limited to, a first cold plate, which may be arranged adjacent a bottom side of the first layer of battery cells, and a second cold plate, which may be arranged adjacent a top side of the first layer of battery cells and, which may be arranged adjacent to a bottom side of the second layer of battery cells.

According to one aspect of the disclosure, the battery module may further include a third cold plate, which may be arranged adjacent to a top side of the second layer of battery cells and adjacent to a bottom side of the third layer of battery cells, and a fourth cold plate, which may be arranged adjacent to a top side of the third layer of battery cells.

At least one of a plurality of thermal interface layers may be arranged adjacent to at least one of the plurality of cold plates. The at least one of the plurality of thermal interface layers may be arranged adjacent to the bottom sides of the at least one of the plurality of battery cells.

According to one aspect of the present disclosure, at least one of the plurality of cold plates may include cooling channels that may be internal to each of the plurality of cold plates, and which may exchange coolant with the cooling system via cold plate input/output ports. The cooling channels may include u-shaped cooling channels.

At least one of the plurality of cold plates may include a plurality of cell vent channels, which may be arranged between the u-shaped cooling channels. The plurality of cell vent channels may include a liner.

At least one of the plurality of cold plates may include stamped cold plates.

Support ribs may be arranged adjacent to at least one of the plurality of cold plates, and a thermal interface layer may be arranged adjacent to at least one of the plurality of cold plates.

According to one aspect of the present disclosure, the battery module enclosure may include a pair of opposing sides, a front portion, a back portion, and a top portion. At least one of the opposing sides of the battery module enclosure may include more than one section.

The support ribs may be shorter in length than the opposing sides of the battery module enclosure. That is, the support ribs may include a length that is shorter than an internal width of the battery module enclosure. The support ribs may be arranged adjacent to at least one of the bottom sides of at least one of the plurality of cold plates.

According to another aspect of the present disclosure, a modular energy storage system may include at least two energy storage enclosures in communication with one another, and a power conversion module element that may be in communication with an external power source and the at least two energy storage enclosures.

Each of the at least two energy storage enclosures may include a battery pack, and a plurality of battery modules arranged within the battery pack. Each of the plurality of battery modules may include a battery module enclosure and bottom plate.

A plurality of battery cells may be arranged within each of the plurality of battery modules. The plurality of battery cells may be arranged in a plurality of columns, which may include, for example but not limited to, a first column that may be arranged adjacent to a second column, and a third column that may be arranged adjacent to the second column. Each of the plurality of columns may include, for example but not limited to, a first layer, a second layer and a third layer.

A plurality of cold plates may be arranged within each of the plurality of battery modules. The plurality of cold plates may include, for example but not limited to, a first cold plate arranged adjacent a bottom side of the first layer of battery cells, and a second cold plate arranged adjacent a top side of the first layer of battery cells and adjacent to a bottom side of the second layer of battery cells.

According to one aspect of the disclosure, the battery module may further include a third cold plate arranged adjacent to a top side of the second layer of battery cells and adjacent to a bottom side of the third layer of battery cells, and a fourth cold plate arranged adjacent to a top side of the third layer of battery cells.

According to another aspect of the present disclosure, a battery module for an energy storage enclosure is disclosed.

The battery module may include a battery module enclosure, a bottom plate, a plurality of battery cells arranged within the battery module enclosure, a plurality of cold plates arranged within the battery module enclosure, and thermal interface layers arranged adjacent to at least one of the plurality of cold plates.

The battery module enclosure may include a pair of opposing sides, a front portion, a back portion, and a top portion.

A plurality of battery cells may be arranged within each of the plurality of battery modules. The plurality of battery cells may be arranged in a plurality of columns, which may include, for example but not limited to, a first column that may be arranged adjacent to a second column, and a third column that may be arranged adjacent to the second column. Each of the plurality of columns may include, for example but not limited to, a first layer, a second layer and a third layer.

Each of the pair of opposing sides of the battery module enclosure may include more than one section.

The plurality of cold plates arranged within the battery module enclosure may include, for example but not limited to, a first cold plate, which may be arranged adjacent a bottom side of the first layer of battery cells, and a second cold plate, which may be arranged adjacent to a top side of the first layer of battery cells and adjacent to a bottom side of the second layer of battery cells.

At least one of the plurality of cold plates may include cooling channels, and a plurality of cell vent channels, which may be arranged within the cooling channels.

By providing cold plates on both sides of the battery cells, the ability to provide cooling to the battery cells may be increased, as may the ability to regulate the internal temperature of the battery cells.

Further, providing the cold plates with cell vent channels in at least one of the cold plates may provide a vent path to vent gases during venting and thermal runaway, which may increase the ability to regulate flow of battery cell off-gassing.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 schematically illustrates an energy storage system including a plurality of energy storage enclosures, in accordance with the disclosure.

FIG. 2 schematically illustrates an energy storage enclosure including a battery pack, in accordance with the disclosure.

FIG. 3 schematically illustrates an exploded view of a battery module in accordance with one aspect of the disclosure.

FIG. 4 schematically illustrates a sectional side view of battery module, in accordance with one aspect of the disclosure.

FIG. 5 schematically illustrates a cross-sectional top view of a cold plate including cooling channels, in accordance with one aspect of the disclosure.

FIG. 6 schematically illustrates a sectional side view of a battery module, in accordance with one aspect of the disclosure.

FIG. 7 schematically illustrates a cross-sectional top view of a battery module enclosure including support structures, in accordance with one aspect of the disclosure.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present disclosure is susceptible of embodiment in many different forms. Representative examples of the disclosure are shown in the drawings and described herein in detail as non-limiting examples of the disclosed principles. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As used herein, the term “plurality” refers to more than at least one of a component, item, or element.

As employed herein, terms such as “vertical”, “horizontal”, “left”, “right”, “upper”, “lower”, “top”, “bottom” and similar expressions are non-limiting terms that merely describe the various elements as illustrated in the Figures and are not intended to limit the scope of the disclosure.

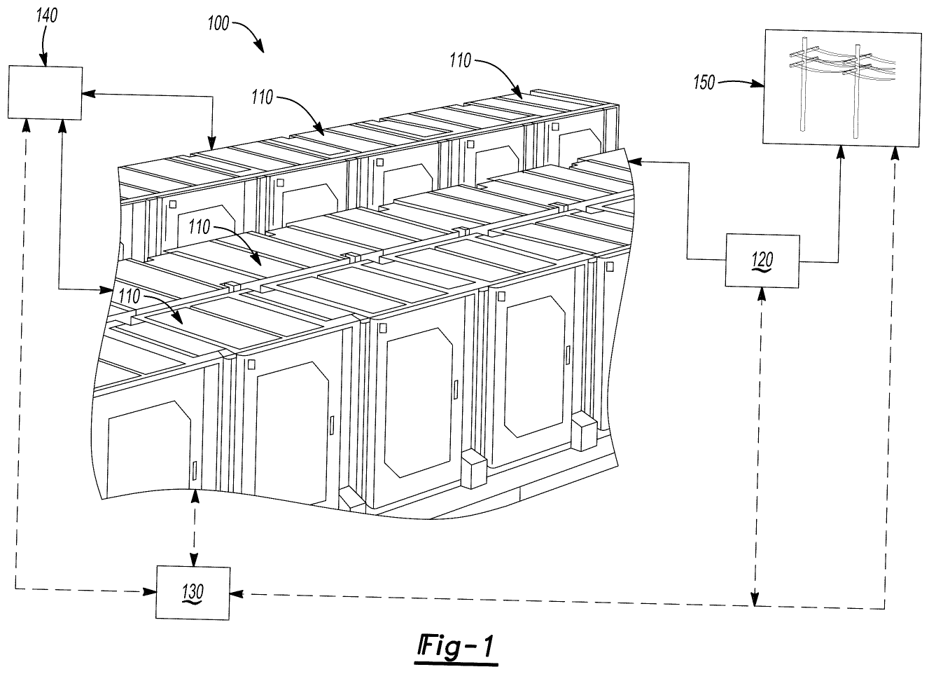

Referring to the drawings, wherein like reference numbers refer to the same or like components in the several Figures, FIG. 1 schematically illustrates an isometric view of an energy storage system 100 including a plurality of energy storage enclosures 110. The energy storage system 100 includes the plurality of energy storage enclosures 110, a power conversion module 120, a controller 130, an external cooling system 140, and an external power source 150.

The plurality of energy storage enclosures 110 are coupled to one another electrically, and collectively coupled to the power conversion module 120, the controller 130, the internal cooling system 140, and the external power source 150. The plurality of energy storage enclosures 110, individually and collectively, are operable to store alternating current (AC) power delivered from the external power source 150 as direct current (DC) power, for example but not limited to when the demand for power from the external power source 150 is lower that the external power source 150 is operable to generate, and/or to provide DC power to the external power source 150, for example but not limited to, when the demand for power is higher than the external power source 150 is operable to generate. It should be appreciated that the plurality of energy storage enclosures 110 may be coupled to one another not only electrically, but also mechanically, and/or fluidly.

To facilitate the conversion of AC power to DC power and DC power to AC power, the power conversion module 120 is configured to standardize power input and output between the plurality of energy storage enclosures 110 and the external power source 150. The power conversion module 120 may include, for example but not limited to, a converter configured to convert AC power to DC power, and/or DC power to AC power.

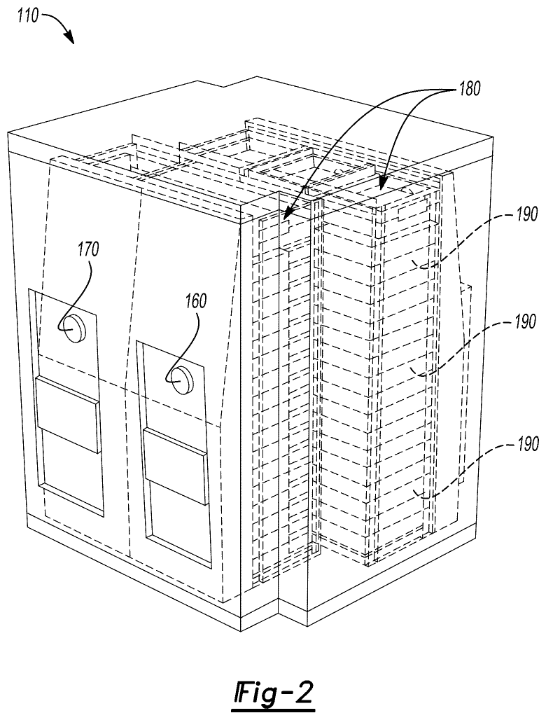

The external cooling system 140 is coupled to the plurality of energy storage enclosures 110, and the controller 130. The external cooling system is configured to provide coolant at a first temperature T₁ to the plurality of energy storage enclosures 110 through at least one input port 160 and receive coolant from the plurality of energy storage enclosures 110 at a second temperature T₂ from at least output port 170 (FIG. 2), such that T₁ is lower than T₂.

The external cooling system 140 may include, for example but not limited to, a heat exchanging system having a pump, a condenser, a heat exchange, and a sump. It should be appreciated that the at least one input port 160 and the at least one output port 170 may include more than one input port 160 and/or one output port 170, and each of which may be arranged in one or more of the plurality of energy storage enclosures 110.

The external power source 150 is coupled to the plurality of energy storage enclosures 110. The external power source 150 is operable to provide AC power converted to DC power to the plurality of energy storage enclosures 110 to be stored as DC power, and to receive AC power converted from DC power from the plurality of energy storage enclosures 110, as discussed above.

The controller 130 is in communication with the plurality of energy storage enclosures 110, the power conversion module 120, the external cooling system 140, and the external power source 150, and is configured to control the aforementioned plurality of energy storage enclosures 110, the power conversion module 120, the external cooling system 140, and their communication with the external power source 150.

The term “controller” and related terms such as microcontroller, control module, module, control, control unit, processor, and similar terms refer to one or various combinations of Application Specific Integrated Circuit(s) (ASIC), Field-Programmable Gate Array (FPGA), electronic circuit(s), central processing unit(s), e.g., microprocessor(s) and associated memory component(s) in the form of transitory and/or non-transitory memory component(s) and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital inverters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables.

As schematically illustrated in FIG. 2, an energy storage enclosure 100 includes a battery pack 180, and a plurality of battery modules 190 arranged within the battery pack 180.

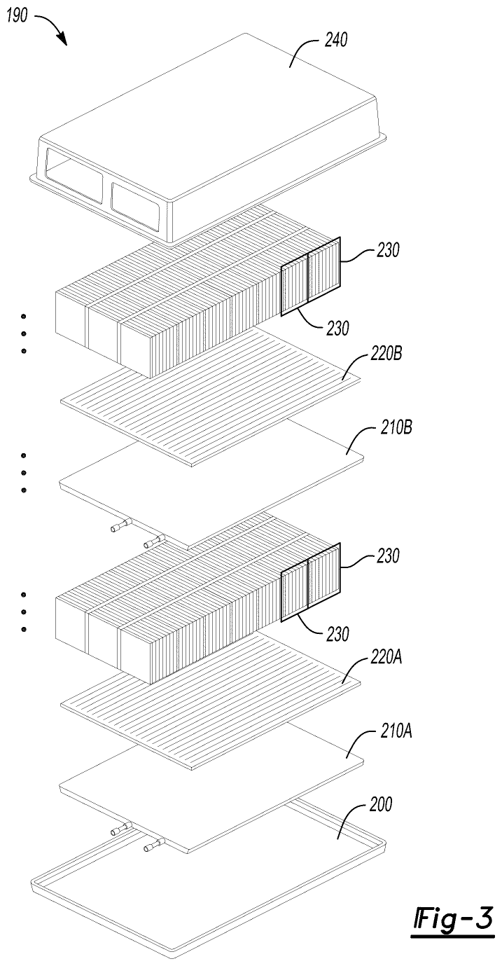

An exploded view of one of the plurality of battery modules 190 is schematically illustrated in FIG. 3. The battery module 190 includes a bottom plate 200, a plurality of cold plates 210A-D, a plurality of thermal interface layers 220A-D, a plurality of battery cells 230, and a battery module enclosure 240.

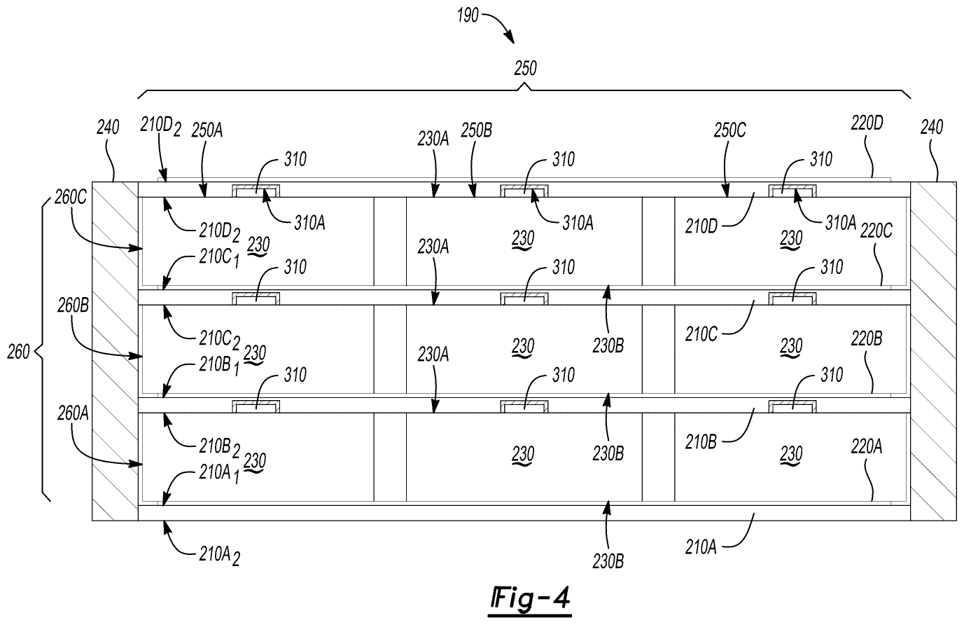

A sectional side view of one of the plurality of battery modules 190 is schematically illustrated in FIG. 4. The battery module 190 includes a plurality of battery cells 230 arranged within the battery module 190 such that the plurality of battery cells 230 is arranged in a plurality of columns 250 including, for example but not limited to, a first column 250AA that is adjacent to a second column 250B, and a third column 250C that is adjacent to the second column 250B. Each of the plurality of columns 250 includes a plurality of layers 260, for example but not limited to, a first layer 260A, a second layer 260B, and a third layer 260C.

A plurality of cold plates 210A-D is arranged within each of the plurality of battery modules 190. The plurality of cold plates 210A-D includes, for example but not limited to, a first cold plate 210A arranged adjacent a bottom side 230B of the first layer 260A of battery cells 230, a second cold plate 210B arranged adjacent a top side 230A of the first layer 260A of battery cells 230 and adjacent to a bottom side 230B of the second layer 260B of battery cells 230, and a third cold plate 210C arranged adjacent to a top side 230A of the second layer 260B of battery cells 230 and adjacent to a bottom side 230B of the third layer 260C of battery cells 230, and a fourth cold plate 210D arranged adjacent to a top side 230A of the third layer 260C of battery cells 230.

The plurality of cold plates 210A-D may include, but are not limited to, stamped cold plates.

At least one of the plurality of thermal interface layers 220A-220D is arranged adjacent to at least one of the plurality of cold plates 210A-D respectively. The at least one of the plurality of thermal interface layers 220A-D may be arranged adjacent to the bottom sides 230B of the at least one of the plurality of battery cells 230.

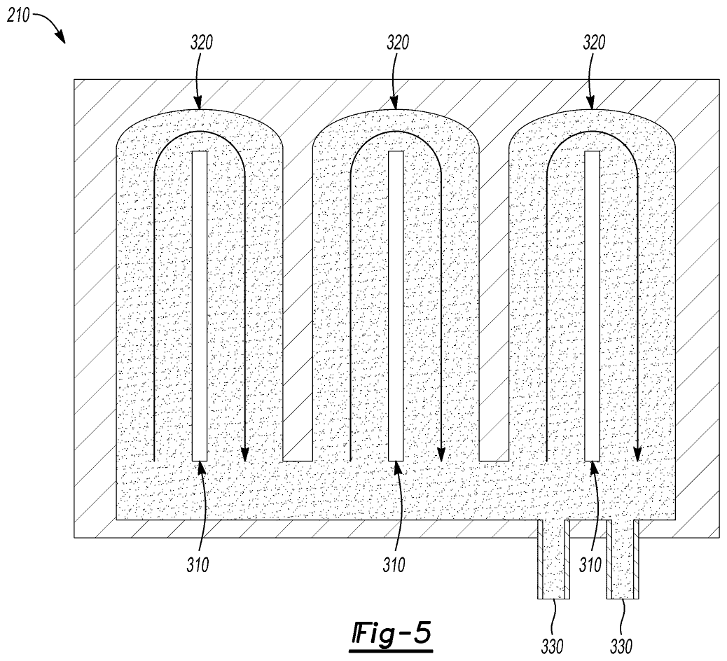

At least one of the plurality of cold plates 210A-D includes a plurality of cell vent channels 310, which may be arranged between u-shaped cooling channels (FIG. 5). The plurality of cell vent channels 310 may include a liner 310A, which may include but is not limited to, a mica liner, and/or an exoskeleton of stamped steel nested within the plurality of cell vent channels 310, a vent path to vent gases, which may increase the ability to regulate flow of battery cell off-gassing during venting and thermal runaway.

It should be appreciated that, while three columns 250A-C of battery cells 230, three layers 260A-C of battery cells 230, four cold plates 210A-D, and four thermal interface layers 220A-D are illustrated, more or less than three columns of battery cells, three layers of battery cells, four cold plates, and four thermal interface layers may be included in one battery module 190, as required by each individual application.

A cross-sectional top view of one of the plurality of cold plates 210A-D is schematically illustrated in FIG. 5. At least one of the cold plates 210A-D includes cooling channels 320 that are internal to each of the cold plates 210A-D, and which exchange coolant with the cooling system 140 via cold plate input/output ports 330. According to one aspect of the disclosure, the cooling channels include u-shaped cooling channels. It should be appreciated, however, that the cooling channels may have alternate configurations, and each of the plurality of cold plates 210A-D may not have cooling channels of the same configuration.

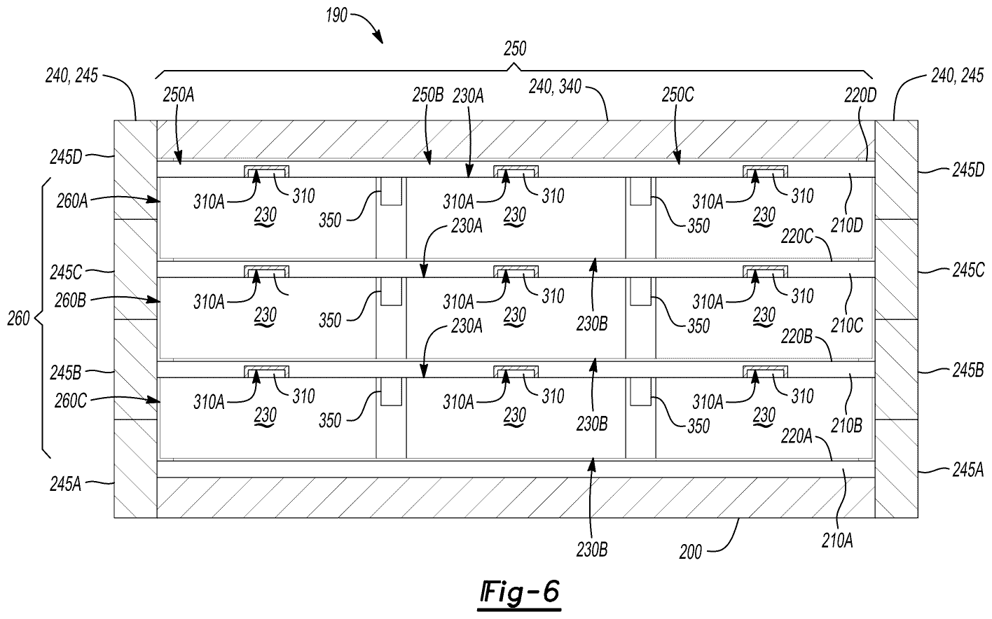

According to one aspect of the present disclosure, as illustrated in FIG. 6, a battery module 190 includes a battery module enclosure 240 and a bottom plate 200. The battery module enclosure 240 includes a pair of opposing sides 245, each of which may include a plurality of sections 245A-D, which facilitates the multi-layering of batteries within each of the plurality of battery modules 190, and a top portion 340. The plurality of sections 245A-D may include at least one extruded section that provides structural support for at least one of the plurality of cold plates 210A-D.

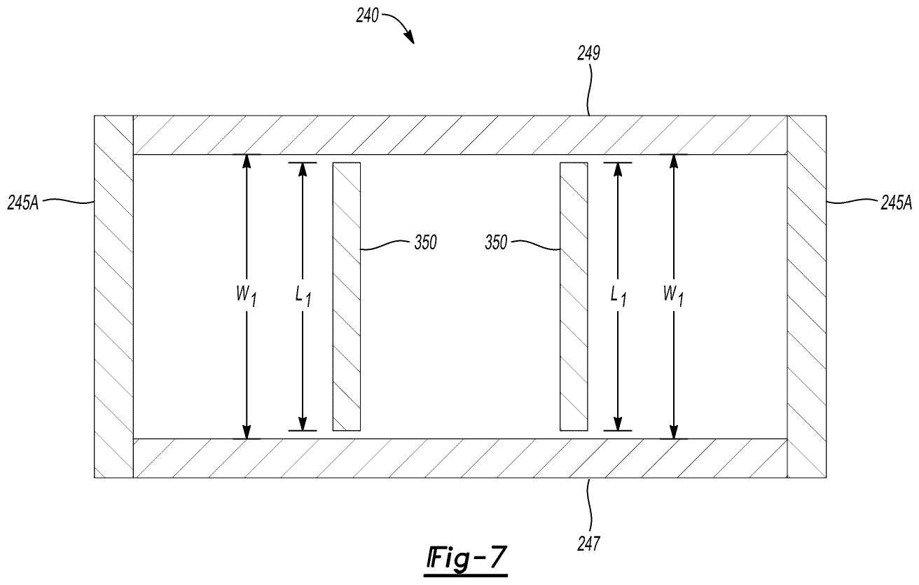

Support ribs 350 are arranged adjacent to at least one of the plurality of cold plates 201A-D. The support ribs 350 include a length Li that is shorter than an internal width W₁ of the battery module enclosure 240, as illustrated in FIG. 7. The support ribs 350 may be arranged adjacent to at least one of the bottom sides 210A₂-D₂ of the at least one of the plurality of cold plates 210A-D respectively.

According to another aspect of the present disclosure, a modular energy storage system 100 includes at least two energy storage enclosures 110 coupled to one another, and a power conversion module 120 that is coupled to an external power source 150 and the at least two energy storage enclosures 110.

Each of the at least two energy storage enclosures 110 includes a battery pack 180, and a plurality of battery modules 190 arranged within the battery pack 180. Each of the plurality of battery modules 190 includes a battery module enclosure 240 and a bottom plate 200.

A plurality of battery cells 230 is arranged within each of the plurality of battery modules 190, such that the plurality of battery cells 230 is arranged in a plurality of columns 250 including, for example but not limited to, a first column 250A that is arranged adjacent to a second column 250B, and a third column 250C that is arranged adjacent to the second column 250B. Each of the plurality of columns 250 includes a plurality of layers 260 including, for example but not limited to, a first layer 260A, a second layer 260B, and a third layer 260C.

A plurality of cold plates 210A-D is arranged within each of the plurality of battery modules 190. The plurality of cold plates 210A-D includes, for example but not limited to, a first cold plate 210A arranged adjacent a bottom side 280A of the first layer 260A of battery cells 230, and a second cold plate 210B arranged adjacent a top side 280B of the first layer 260A of battery cells 230 and adjacent to a bottom side 290A of the second layer 260B of battery cells 230.

According to another aspect of the present disclosure, the battery module 190 includes a third cold plate 210C arranged adjacent to a top side 290B of the second layer 260B of battery cells 230 and adjacent to a bottom side 300A of the third layer 260C of battery cells 230, and a fourth cold plate 210D arranged adjacent to a top side 300B of the third layer 260C of battery cells 230.

According to another aspect of the present disclosure, a battery module 190 for an energy storage enclosure 110 includes a battery module enclosure 240, a bottom plate 200, a plurality of battery cells arranged within the battery module enclosure 240, a plurality of cold plates 210A-D arranged within the battery module enclosure 240, and thermal interface layers 220A-D arranged adjacent to at least one of the plurality of cold plates 210A-D respectively.

The battery module enclosure 240 includes a pair of opposing sides 245, a front portion 247, a back portion 249, and a top portion 340.

The plurality of battery cells 230 is arranged in a plurality of columns 250 including, for example but not limited to, a first column 250A that is adjacent to a second column 250B, and a third column 250C that is adjacent to the second column 250B. Each of the plurality of columns 250 includes a plurality of layers 260, for example but not limited to, a first layer 260A, a second layer 260B, and a third layer 260C.

The pair of opposing sides 245 of the battery module enclosure 240 each includes more than one section 245A-D.

The plurality of cold plates 210A-D arranged within the battery module enclosure 240 includes, for example but not limited to, a first cold plate 210A arranged adjacent a bottom side 230B of the first layer 260A of battery cells 230, and a second cold plate 210B arranged adjacent to a top side 230A of the first layer 260A of battery cells 230 and adjacent to a bottom side 230B of the second layer 260B of battery cells 230.

At least one of the plurality of cold plates 210A-D includes cooling channels 320, and a plurality of cell vent channels 310 arranged within the cooling channels 320.

By providing cold plates on both sides of the battery cells, the ability to provide cooling to the battery cells may be increased, as may the ability to regulate the internal temperature of the battery cells.

Further, providing the cold plates with cell vent channels in at least one of the cold plates may also increase the ability to regulate flow of battery cell off-gassing during venting and thermal runaway.

By providing cold plates having differing internal cooling channel configurations within one battery module, the ability to regulate the internal temperature of the battery cells within the battery module may also be increased.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other examples for carrying out the present teachings have been described in detail, various alternative designs and aspects of the disclosure exist for practicing the present teachings defined in the appended claims.

What is claimed is:

1. An energy storage system comprising:
a battery pack;
a plurality of battery modules arranged within the battery pack, each of the plurality of battery modules including:
a battery module enclosure;
a plurality of battery cells arranged within the battery module enclosure; and
a plurality of cold plates arranged within each of the plurality of battery modules.

2. The energy storage system as recited in claim 1, wherein the plurality of battery cells is arranged in a plurality of layers, and
wherein at least one of the plurality of cold plates is arranged adjacent to one of a bottom side of one of the plurality of layers, and at least another of the plurality of cold plates is arranged adjacent to a top side of the one of the plurality of layers.

3. The energy storage system as recited in claim 2, wherein the plurality of layers includes:
a first layer;
a second layer; and
a third layer; and
wherein the plurality of cold plates further includes:
a first cold plate arranged adjacent a bottom side of the first layer of battery cells;
a second cold plate arranged adjacent a top side of the first layer of battery cells and adjacent to a bottom side of the second layer of battery cells;
a third cold plate arranged adjacent to a top side of the second layer of battery cells and adjacent to a bottom side of the third layer of battery cells; and
a fourth cold plate arranged adjacent to a top side of the third layer of battery cells.

4. The energy storage system as recited in claim 1, wherein the plurality of cold plates includes a cooling channel.

5. The energy storage system as recited in claim 4, wherein the cooling channel includes a u-shaped cooling channel.

6. The energy storage system as recited in claim 5, wherein the plurality of cold plates includes a cell vent channel.

7. The energy storage system as recited in claim 6, wherein the cell vent channel is arranged within the u-shaped cooling channel.

8. The energy storage system as recited in claim 1, further including at least one support rib arranged adjacent to at least one of the plurality of cold plates.

9. The energy storage system as recited in claim 1, further including a thermal interface layer arranged adjacent to at least one of the plurality of cold plates.

10. The energy storage system as recited in claim 1, wherein the battery module enclosure includes a pair of opposing sides, a front portion, a back portion, and a top portion.

11. The energy storage system as recited in claim 10, wherein each of the pair of opposing sides of the battery module enclosure includes more than one section.

12. The energy storage system as recited in claim 10, wherein the battery module enclosure includes support ribs that are shorter in length than the opposing sides of the battery module enclosure.

13. A modular energy storage system comprising:
at least two energy storage systems coupled to one another;
a power conversion module coupled to an external power source and the at least two energy storage systems, wherein each of the at least two energy storage systems includes:
a battery pack;
a plurality of battery modules arranged within the battery pack, each of the plurality of battery modules having a battery module enclosure and a bottom plate;
a plurality of battery cells arranged within each of the plurality of battery modules, wherein the plurality of battery cells is arranged in a plurality of layers; and
a plurality of cold plates arranged within each of the plurality of battery modules, wherein the at least one of the plurality of cold plates is arranged adjacent to a bottom side of one of the plurality of layers, and another of the plurality of cold plates is arranged adjacent to a top side of the one of the plurality of layers.

14. A battery module for an energy storage system, the battery module comprising:
a battery module enclosure;
a bottom plate, wherein the battery module enclosure includes:
a pair of opposing sides, wherein each of the opposing sides includes more than one section;
a front portion;
a back portion; and
a top portion; and
a plurality of battery cells arranged within the battery module enclosure, wherein the plurality of battery cells is arranged in a plurality of layers; and
a plurality of cold plates arranged within the battery module.

15. The battery module as recited in claim 14, wherein the plurality of battery cells is arranged in a plurality of layers, and
wherein at least one of the plurality of cold plates is arranged adjacent to one of a bottom side of one of the plurality of layers, and at least another of the plurality of cold plates is arranged adjacent to a top side of the one of the plurality of layers.

16. The battery module as recited in claim 15, wherein the plurality of layers includes:
a first layer;
a second layer; and
a third layer; and
wherein the plurality of cold plates further includes:
a first cold plate arranged adjacent a bottom side of the first layer of battery cells;
a second cold plate arranged adjacent a top side of the first layer of battery cells and adjacent to a bottom side of the second layer of battery cells;
a third cold plate arranged adjacent to a top side of the second layer of battery cells and adjacent to a bottom side of the third layer of battery cells; and
a fourth cold plate arranged adjacent to a top side of the third layer of battery cells.

17. The battery module as recited in claim 14, wherein at least one of the plurality of cold plates includes cooling channels.

18. The battery module as recited in claim 17, wherein the cooling channels include u-shaped cooling channels.

19. The battery module as recited in claim 14, wherein at least one of the plurality of cold plates includes a plurality of cell vent channels.

20. The battery module as recited in claim 14, including support ribs arranged adjacent to at least one of the plurality of cold plates.
